(19) United States
(12) Patent Application Publication
(10) Pub. No.: US 2007/0088573 A1
(43) Pub. Date: Apr. 19, 2007

(54) METHOD AND INTERFACE FOR ADAPTIVE RADIATION THERAPY

(76) Inventors: Kenneth J. Ruchala, Madison, WI (US); Gustavo H. Olivera, Madison, WI (US); Eric Schnarr, McFarland, WI (US); Jason Haimerl, Lake Mills, WI (US); Weiguo Lu, Madison, WI (US); Quan Chen, Madison, WI (US)

Correspondence Address: MICHAEL BEST & FRIEDRICH, LLP, 100 E WISCONSIN AVENUE, Suite 3300, MILWAUKEE, WI, 53202, US

(21) Appl. No.: 11/459,052

(22) Filed: Jul. 21, 2006

Related U.S. Application Data
(60) Provisional application No. 60/726,548, filed on Oct. 14, 2005.

(51) Int. Cl. G06Q 10/00; G06Q 50/00

(52) U.S. Cl. 705/2

(57) ABSTRACT

A system and method for developing and analyzing radiation therapy treatment plans and a computer-generated user interface for presenting data relating to a radiation therapy treatment plan. The user interface includes a list of fractions identified in the treatment plan, data identifying delivery status of the fraction, and data identifying a processing status of the fraction. The system includes a computer processor, a data store connected to the computer processor and storing information relating to at least one fraction of a radiation therapy treatment plan, which fraction has been delivered to a patient as part of the implementation of the radiation therapy treatment plan, and software, stored in a computer readable medium accessible by the computer processor, the software being operable to automatically process the information relating to the at least one fraction.

### RELATED APPLICATIONS

This application claims priority to U.S. Provisional Patent Application No. 60/726,548, filed on Oct. 14, 2005, titled “METHOD AND INTERFACE FOR ADAPTIVE RADIATION THERAPY”, the entire content of which is incorporated herein by reference.

### BACKGROUND

Adaptive radiation therapy, or ART, is the concept of incorporating feedback into radiation therapy practice. A wide array of processes have been referred to as ART, including: repositioning a patient using on-line imaging, recontouring and replanning a patient using a combination of patient images, and modifying a patient plan based upon dose recalculations.

### SUMMARY OF THE INVENTION

One comprehensive version of ART builds upon modifying a patient plan based upon delivered dose. Before or during a patient's treatment delivery, an on-line image set is collected. Additional feedback may be received during the delivery indicating machine functional information and/or patient transmission data. This information, the patient images, and potential patient plan information is then processed to determine the dose that the patient actually received from the treatment. This processing can be performed either on-the-fly or as a post-process.

The delivered dose information can be added across each treatment fraction the patient received. As a result of patient anatomical and physiological changes, it is appropriate to determine the deformation and/or tissue-mapping that represents the patient anatomical and physiological changes that may have occurred during the course of treatment. Likewise, a contour set that defines the treatment and avoidance regions of the patient can change, and these contours can be updated.

Once all of this information is processed, the radiation therapy treatment system can determine the accumulated dose received by the patient, and organize that information according to specific targets or avoidance regions. Based upon this information, the system can create a new plan for the patient that better accounts for any changes in the patient or for any off-course delivery. Also, the system can evaluate hypothetical situations, such as how a patient treatment would have been affected by using different protocols, different plans, etc.

Many processing steps are usually performed in order to complete this type of ART evaluation, which results in many auxiliary data sets. For example, each fraction may require a deformation map relating a daily image to the planning image, an updated contour set, and an updated dose. Since each patient might receive upwards of 30 fractions, this is a large number of files to manage. Moreover, there can be many additional files, from important pre-processing steps, such as detector data analysis, or image manipulations to account for density calibrations or corrections, couch differences, incomplete image padding, etc. Finally, it should be noted that the number of files can then grow exponentially as hypothetical delivery options are explored, such as evaluating not only the planned and delivered doses, but the doses that would have been delivered for different patient positions, or with different combinations of delivery plans.

As such, one aspect of this invention is to provide a graphical user interface (“GUI”) and framework for managing this data. In particular, the user need not organize or maintain the plethora of data files required for the adaptive analysis, but instead can focus on a dashboard that provides an overview of all of the processing that has been performed.

The invention also provides a computer-generated user interface for presenting data relating to a radiation therapy treatment plan. The user interface comprises a list of fractions identified in the treatment plan, data identifying delivery status of the fraction, and data identifying a processing status of the fraction, and wherein the processing status relates to data acquired before, during, or after treatment to retrospectively analyze the delivery.

The invention also provides a system for developing and analyzing radiation therapy treatment plans. The system comprises a computer processor, a data store, and software. The data store is connected to the computer processor and stores information relating to at least one fraction of a radiation therapy treatment plan, which fraction has been delivered to a patient as part of the implementation of the radiation therapy treatment plan, information relating to a delivery status of the fraction, and information relating to a processing status of the fraction. The software is stored in a computer readable medium accessible by the computer processor and is operable to automatically process the information relating to the at least one fraction, and wherein the processing status relates to data acquired before, during, or after treatment to retrospectively analyze the delivery.

The invention also provides a method of evaluating a radiation therapy treatment plan. The method comprises the acts of acquiring a reference image of at least a portion of a patient, accessing a list of fractions identified in the treatment plan for the patient, each fraction being associated with a set of delivery conditions or parameters, retrieving an image associated with one of the fractions, generating a deformation map between the reference image and the image associated with one of the fractions, and evaluating a radiation dose that would have been delivered to the patient for at least one of the fractions if any of the delivery conditions or parameters were different.

### BRIEF DESCRIPTION OF THE DRAWINGS

FIG. 1 is a perspective view of a radiation therapy treatment system.

FIG. 2 illustrates a perspective view of a multi-leaf collimator that can be used in the radiation therapy treatment system illustrated in FIG. 1.

FIG. 3 is a schematic illustration of the radiation therapy treatment system of FIG. 1.

FIG. 4 illustrates a screen generated by the radiation therapy treatment system illustrated in FIG. 1, and showing the status of fractions of a treatment plan.

FIG. 5 illustrates a screen generated by the radiation therapy system illustrated in FIG. 1, and shows a comparison of the treatment plan and the actual dose delivered to the patient.

FIG. 6 illustrates a screen generated by the radiation therapy system illustrated in FIG. 1, and shows a comparison of the treatment plan and a hypothetical dose.

FIG. 7 is a flow chart of a method of evaluating a radiation therapy treatment plan according to one embodiment of the present invention.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

Although directional references, such as upper, lower, downward, upward, rearward, bottom, front, rear, etc., may be made herein in describing the drawings, these references are made relative to the drawings (as normally viewed) for convenience. These directions are not intended to be taken literally or limit the present invention in any form. In addition, terms such as “first”, “second”, and “third” are used herein for purposes of description and are not intended to indicate or imply relative importance or significance.

In addition, it should be understood that embodiments of the invention include both hardware, software, and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic based aspects of the invention may be implemented in software. As such, it should be noted that a plurality of hardware and software based devices, as well as a plurality of different structural components may be utilized to implement the invention. Furthermore, and as described in subsequent paragraphs, the specific mechanical configurations illustrated in the drawings are intended to exemplify embodiments of the invention and that other alternative mechanical configurations are possible.

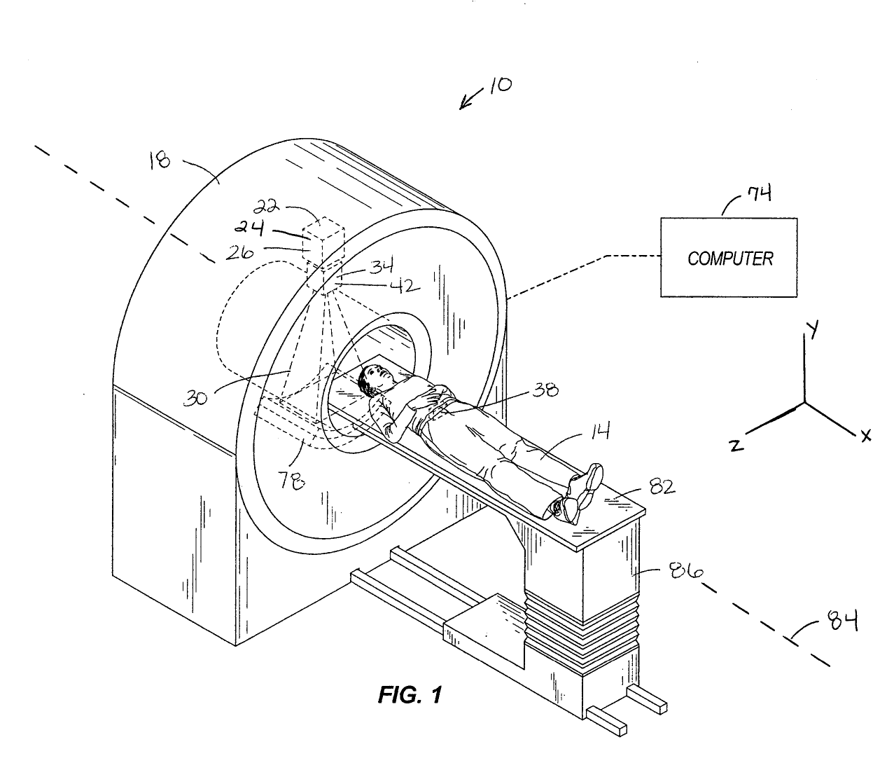

FIG. 1 illustrates a radiation therapy treatment system 10 that can provide radiation therapy to a patient 14. The radiation therapy treatment can include photon-based radiation therapy, brachytherapy, electron beam therapy, proton, neutron, or particle therapy, or other types of treatment therapy. The radiation therapy treatment system 10 includes a gantry 18. The gantry 18 can support a radiation module 22, which can include a radiation source 24 and a linear accelerator 26 operable to generate a beam 30 of radiation. Though the gantry 18 shown in the drawings is a ring gantry, i.e., it extends through a full 360° arc to create a complete ring or circle, other types of mounting arrangements may also be employed. For example, a C-type, partial ring gantry, or robotic arm could be used. Any other framework capable of positioning the radiation module 22 at various rotational and/or axial positions relative to the patient 14 may also be employed. In addition, the radiation source 24 may travel in path that does not follow the shape of the gantry 18. For example, the radiation source 24 may travel in a non-circular path even though the illustrated gantry 18 is generally circular-shaped.

The radiation module 22 can also include a modulation device 34 operable to modify or modulate the radiation beam 30. The modulation device 34 provides the modulation of the radiation beam 30 and directs the radiation beam 30 toward the patient 14. Specifically, the radiation beam 34 is directed toward a portion of the patient. Broadly speaking, the portion may include the entire body, but is generally smaller than the entire body and can be defined by a two-dimensional area and/or a three-dimensional volume. A portion desired to receive the radiation, which may be referred to as a target 38 or target region, is an example of a region of interest. Another type of region of interest is a region at risk. If a portion includes a region at risk, the radiation beam is preferably diverted from the region at risk. The patient 14 may have more than one target region that needs to receive radiation therapy. Such modulation is sometimes referred to as intensity modulated radiation therapy (“IMRT”).

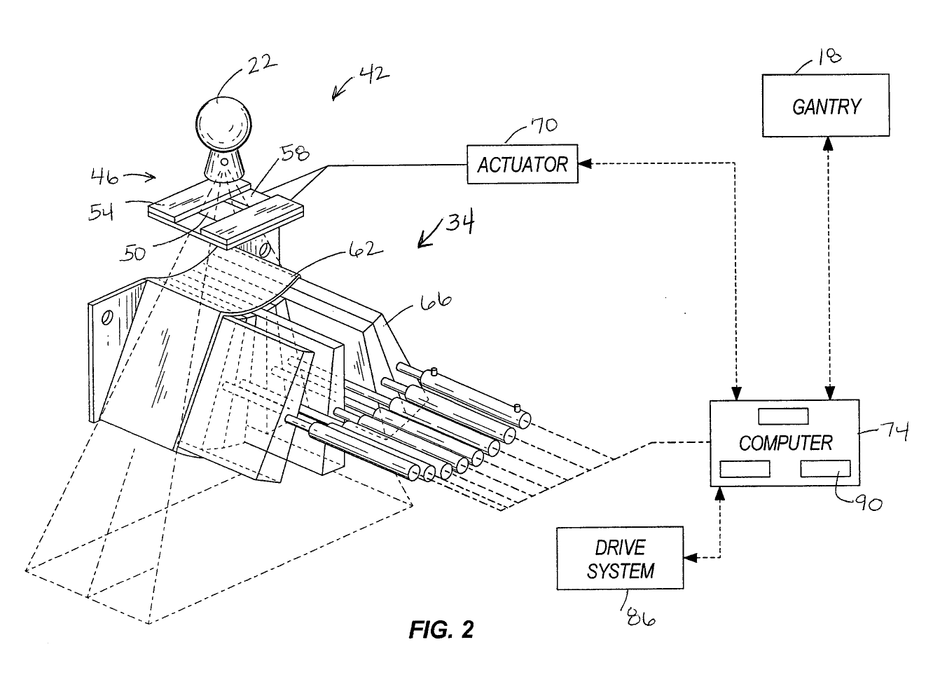

The modulation device 34 can include a collimation device 42 as illustrated in FIG. 2. The collimation device 42 includes a set of jaws 46 that define and adjust the size of an aperture 50 through which the radiation beam 30 may pass. The jaws 46 include an upper jaw 54 and a lower jaw 58. The upper jaw 54 and the lowerjaw 58 are moveable to adjust the size of the aperture 50.

In one embodiment, and illustrated in FIG. 2, the modulation device 34 can comprise a multi-leaf collimator 62, which includes a plurality of interlaced leaves 66 operable to move from position to position, to provide intensity modulation. It is also noted that the leaves 66 can be moved to a position anywhere between a minimally and maximally-open position. The plurality of interlaced leaves 66 modulate the strength, size, and shape of the radiation beam 30 before the radiation beam 30 reaches the target 38 on the patient 14. Each of the leaves 66 is independently controlled by an actuator 70, such as a motor or an air valve so that the leaf 66 can open and close quickly to permit or block the passage of radiation. The actuators 70 can be controlled by a computer 74 and/or controller.

The radiation therapy treatment system 10 can also include a detector 78, e.g., a kilovoltage or a megavoltage detector, operable to receive the radiation beam 30. The linear accelerator 26 and the detector 78 can also operate as a computed tomography (CT) system to generate CT images of the patient 14. The linear accelerator 26 emits the radiation beam 30 toward the target 38 in the patient 14. The target 38 absorbs some of the radiation. The detector 78 detects or measures the amount of radiation absorbed by the target 38. The detector 78 collects the absorption data from different angles as the linear accelerator 26 rotates around and emits radiation toward the patient 14. The collected absorption data is transmitted to the computer 74 to process the absorption data and to generate images of the patient's body tissues and organs. The images can also illustrate bone, soft tissues, and blood vessels.

The CT images can be acquired with a radiation beam 30 that has a fan-shaped geometry, a multi-slice geometry or a cone-beam geometry. In addition, the CT images can be acquired with the linear accelerator 26 delivering megavoltage energies or kilovoltage energies. It is also noted that the acquired CT images can be registered with previously acquired CT images (from the radiation therapy treatment system 10 or other image acquisition devices, such as other CT scanners, MRI systems, and PET systems). For example, the previously acquired CT images for the patient 14 can include identified targets 38 made through a contouring process. The newly acquired CT images for the patient 14 can be registered with the previously acquired CT images to assist in identifying the targets 38 in the new CT images. The registration process can use rigid or deformable registration tools.

In some embodiments, the radiation therapy treatment system 10 can include an x-ray source and a CT image detector. The x-ray source and the CT image detector operate in a similar manner as the linear accelerator 26 and the detector 78 as described above to acquire image data. The image data is transmitted to the computer 74 where it is processed to generate images of the patient's body tissues and organs.

The radiation therapy treatment system 10 can also include a patient support, such as a couch 82 (illustrated in FIG. 1), which supports the patient 14. The couch 82 moves along at least one axis 84 in the x, y, or z directions. In other embodiments of the invention, the patient support can be a device that is adapted to support any portion of the patient's body. The patient support is not limited to having to support the entire patient's body. The system 10 also can include a drive system 86 operable to manipulate the position of the couch 82. The drive system 86 can be controlled by the computer 74.

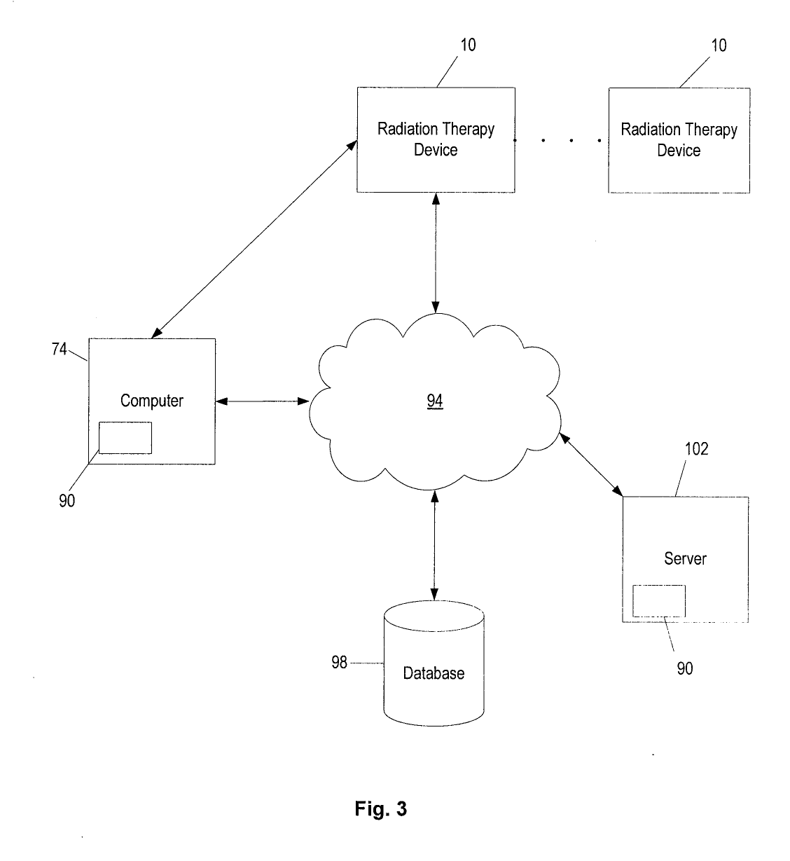

The computer 74, illustrated in FIGS. 2 and 3, includes an operating system for running various software programs and/or a communications application. In particular, the computer 74 can include a software program(s) 90 that operates to communicate with the radiation therapy treatment system 10. The software program(s) 90 is operable to receive data from external software programs and hardware and it is noted that data may be input to the software program(s) 90.

The computer 74 can include any suitable input/output device adapted to be accessed by medical personnel. The computer 74 can include typical hardware such as a processor, I/O interfaces, and storage devices or memory. The computer 74 can also include input devices such as a keyboard and a mouse. The computer 74 can further include standard output devices, such as a monitor. In addition, the computer 74 can include peripherals, such as a printer and a scanner.

The computer 74 can be networked with other computers 74 and radiation therapy treatment systems 10. The other computers 74 may include additional and/or different computer programs and software and are not required to be identical to the computer 74, described herein. The computers 74 and radiation therapy treatment system 10 can communicate with a network 94. The computers 74 and radiation therapy treatment systems 10 can also communicate with a database(s) 98 and a server(s) 102. The database 98 is a data store or data storage location and operates as a depository for data. It is noted that the software program(s) 90 could also reside on the server(s) 102.

The network 94 can be built according to any networking technology or topology or combinations of technologies and topologies and can include multiple sub-networks. Connections between the computers and systems shown in FIG. 3 can be made through local area networks (“LANs”), wide area networks (“WANs”), public switched telephone networks (“PSTNs”), wireless networks, Intranets, the Internet, or any other suitable networks. In a hospital or medical care facility, communication between the computers and systems shown in FIG. 3 can be made through the Health Level Seven (“HL7”) protocol or other protocols with any version and/or other required protocol. HL7 is a standard protocol which specifies the implementation of interfaces between two computer applications (sender and receiver) from different vendors for electronic data exchange in health care environments. HL7 can allow health care institutions to exchange key sets of data from different application systems. Specifically, HL7 can define the data to be exchanged, the timing of the interchange, and the communication of errors to the application. The formats are generally generic in nature and can be configured to meet the needs of the applications involved.

Communication between the computers and systems shown in FIG. 3 can also occur through the Digital Imaging and Communications in Medicine (“DICOM”) protocol with any version and/or other required protocol. DICOM is an international communications standard developed by NEMA that defines the format used to transfer medical image-related data between different pieces of medical equipment. DICOM RT refers to the standards that are specific to radiation therapy data.

The two-way arrows in FIG. 3 generally represent two-way communication and information transfer between the network 94 and any one of the computers 74 and the systems 10 shown in FIG. 3. However, for some medical and computerized equipment, only one-way communication and information transfer may be necessary.

The software program 90 generates a user interface embodied by a plurality of “screens” or “pages,” which the user interacts with to communicate with the software program 90. As such, all of the screens of the user interface are not limited to the arrangement as shown in any of the drawings. The screens may include, but are not limited to fields, columns, rows, dialog boxes, tabs, buttons, radio buttons, and drop down menus. Field titles may vary and are not limited to that shown in the drawings.

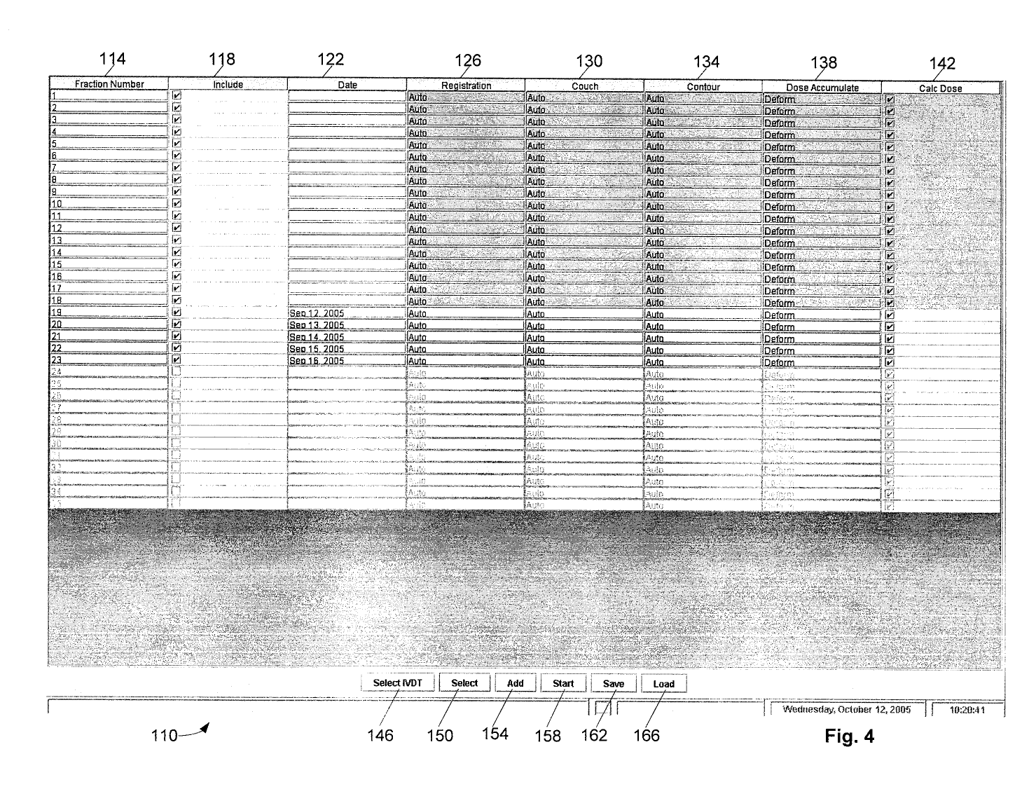

FIG. 4 illustrates one screen 110 of the user interface, which includes a spreadsheet-like format that illustrates a radiation therapy treatment plan for the patient 14. While the computer 74 generating the user interface is shown connected to the radiation therapy treatment system 10, the computer 74 may also be a part of a stand-alone system for generating radiation therapy treatment plans and analyzing data generated during delivery of a radiation therapy treatment plan.

As illustrated in FIG. 4, the screen 110 includes a plurality of columns of data related to the treatment plan. Specifically, the screen 110 includes a number of treatment fractions column 114, an “Include” column 118, a date column 122, a registration column 126, a couch column 130, a contour column 134, a dose accumulation column 138, and a calculate dose column 142 that relate to the radiation therapy treatment plan for the patient 14. The number of fractions column 114 indicates the number of radiation treatments or radiation doses that will be delivered to the patient 14 during the radiation therapy treatment plan. The “Include” column 118 indicates that these fractions should be processed and included in the summation dose. The date column 122 indicates the date that a radiation dose was delivered or is scheduled to be delivered to the patient 14. The registration column 126 indicates the method to be used for registering the patient for evaluation. For example, the evaluation of the patient 14 can be based upon the actual registration used for the treatment, or it might evaluate results for hypothetical patient positions. These hypothetical positions might include anything from the no-patient-registration (the original setup without image guidance), alternate registrations defined but not used during treatment, manual registration, automatic registration using fiducial markers, automatic registration using mutual information, extracted feature fusion, or other automatic algorithms, etc. The couch column 130 indicates that couch replacement will be performed automatically. The contour column 134 indicates the selected method for contour generation. The options can include manual contouring, deformation-based contouring, or a variety of auto-contouring algorithms. The default setting can be configured to any preferred method of contouring, but in this example “Auto” is configured to deformation-based contours with the ability to manually review and edit the contours if desired. The dose accumulation column 138 indicates that deformable registration is used for the process of accumulating dose. The calculated dose column 142 indicates radiation dose will be calculated for each of the daily images. Alternative options that can be selected are to not calculate dose (and instead use a predefined dose grid such as the planning dose), to calculate dose using a different plan, or to calculate dose using a different method, such as by using bulk-density replacement.

The screen 110 also includes various buttons for manipulating the radiation therapy treatment plan data. Specifically, the screen 110 includes a Select IVDT button 146, a select button 150, an add button 154, a start button 158, a save button 162, and a load button 166. The Select IVDT button 146 functions to choose or override the default image calibration curve, or image-value-to-density table. This option can also be used to apply other density corrections or processes to the images. The select button 150 allows the user to select a patient and/or set of treatment fractions for analysis. The add button 154 allows the user to add additional treatment fractions to the evaluation. These can be existing fractions, perhaps stored in a different plan, that are brought into the processing, or these might be new fractions, potentially with new or modified plans. The start button 158 initiates processing of the data. The save button 162 functions to save any modifications to the treatment plan and also the processing results of the data. The load button 166 functions to retrieve the current processing status of a patient.

At a glance, it is easy for a user to see which fractions have been both delivered and have had adaptive processing performed (shaded regions, rows 1-18); which fractions have been delivered but not processed (rows 19-23); and which fractions have not yet been delivered (rows 24-35). The contents of each box in the processing columns indicate the type of processing that is to be used. For example, the dose accumulation was performed using deformation. In principle, steps could be evaluated in multiple ways, and a cell might indicate that different types of dose accumulation were performed.

In one form, the computer 74 is programmed to automatically determine what data and/or fractions have been processed, what data and/or fractions are ready for processing, and what data and/or fractions are not available for processing (such as fractions that have not been delivered). Based on this information, the computer 74 performs many or all of the processing tasks with minimal user setup or intervention.

In one exemplary scenario, a user may access the software program 90 that generates the screen 110 roughly once per week for the patient 14. As shown in FIG. 4, the user last accessed the screen 110 after fraction number 18, and all of the data up until that time has been processed. The screen 110 illustrates that five more patient fractions have been delivered and are ready for processing since the user last accessed the screen 110. The software program 90 detects that these five new fractions are available for processing, and automatically selects the preferred processing options (such as based upon a properties/preferences selector, a patient protocol, the processing of previous fractions, or the like). The user can initiate processing by taking an appropriate action such as, for example, clicking the “Start” button 158. The user can allow the software program 90 to run until the data processing is complete. In some implementations, the software program 90 might automatically perform the processing before or during review of the treatment fraction by the user such that the data is already available to review once the user enters the screen.

The software program 90 includes default settings for the screen 110 and the methods of processing the treatment plan data. The user is not required to use the default settings, but may override them (such as on a cell-by-cell level, by column, by patient, etc.). In some cases, such overrides will not affect the automatic processing of the data. In other cases, user intervention may be required during the processing. For example, one option for the registration column 126 might be to evaluate the dose delivered based upon how the patient 14 was set-up or registered for the treatment fraction. Nonetheless, a user may wish to explore how the dose would have been delivered had the patient 14 been treated differently.

As another example, the dose delivered to the patient 14 can be evaluated using a gamma index. The gamma (γ) index is used to simultaneously test both percent dose difference in plateau regions and distance to agreement in high gradient regions. Percent dose difference is a useful metric in regions of uniform dose—the plateau regions - but is not appropriate for high gradient regions. Distance to agreement is a more appropriate metric for high dose gradient regions. The γ index was introduced by Low et. al. (Daniel A. Low, William B. Harms, Sasa Mutic, James A. Purdy, “A technique for the quantitative evaluation of dose distributions,” Medical Physics, Volume 25, Issue 5, May 1998, pp. 656-661.) Given a percent-dose/distance criterion (e.g., 5%-3mm) γ is calculated for every sample point in a dose profile (1-D), image (2-D), or volume (3-D). Wherever γ<=1 the criteria is met; where γ>1 the criteria is not met.

As another example, the dose delivered to the patient 14 can be evaluated using a xi index. The xi (ξ) index is a generalization of the procedure outlined by Van Dyk et al. (1993) for treatment planning commissioning. With this method, both distributions be compared in their gradient components first, followed by a dose-difference (ΔD) and distance-to-agreement (DTA) analysis. Since there are two dose distributions and two dose gradient classifications (high dose gradient or low dose gradient), there are four possible combinations. Given V_{ref} is the voxel in the reference distribution and Vₑᵥₐₗ is the voxel in the evaluation distribution, these combinations are:
V_{ref} is high dose gradient, Vₑᵥₐₗ is high dose gradient
V_{ref} is high dose gradient, Vₑᵥₐₗ is low dose gradient
V_{ref} is low dose gradient, Vₑᵥₐₗ is high dose gradient
V_{ref} is low dose gradient, Vₑᵥₐₗ is low dose gradient

In the proposed comparison tool, for regions in which both the reference and comparison distributions have low dose gradients, ΔD values are obtained. For all other cases, DTA analysis is done. The gradient comparison accounts for the fact that there may be a complete mismatch of dose gradients between the reconstructed and planned distributions. Once ΔD and DTA values are obtained, a numerical index for each voxel can be found that is similar the gamma index proposed by Low et al. (1998). The numerical index ξ is found by the following:

$${ξ}_{high gradient voxels} = \vert \frac{DTA}{DTA tolerance} \vert , {ξ}_{low gradient voxels} = \vert \frac{Δ D}{Δ D tolerance} \vert \qquad ( 1 )$$

A ξ value of one or less is considered acceptable. Though a volume can have both high and low gradient voxels, this approach is amenable to averaging or display since the ξ values are dimensionless.

In these types of cases, the software program 90 can organize the data processing to maximize speed and/or to minimize the number of user interventions. For example, in the case of registration, the user may wish to have all of the data pre-processing to be calculated first by the program, then be able to check or enter some or all of the registration scenarios at once, and then have the software program 90 complete all remaining processing. In this manner, even when user intervention is desired to decide on the details of the processing or evaluation, it can be streamlined and easily understood. Similarly, all of the contours may be automatically generated for each fraction image, but these can all be reviewed (and edited, if necessary) at one discrete time, instead of requiring disparate interactions with the software.

The user interface can also include a scripting language, or macro ability that lets a user more precisely define and record complex preferences. This feature allows the user to specify when and how they wish to be notified, how the processing should be done, or how the results should be evaluated. Similarly, the user interface can include an alerting function, which when processing data, notifies a user if the patient dose exceeds certain thresholds or tolerances. This alerting feature could be used with application processing occurring in the background or automatically, and notifications could include on-screen messages, pages, e-mails, or other methods of rapid communication.

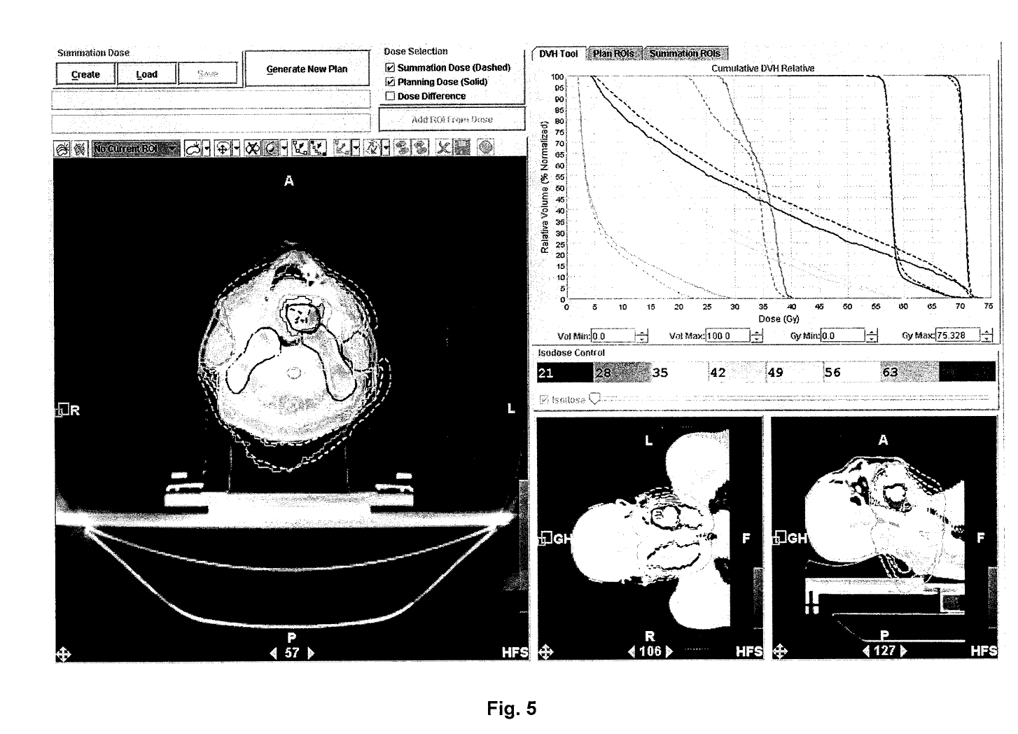

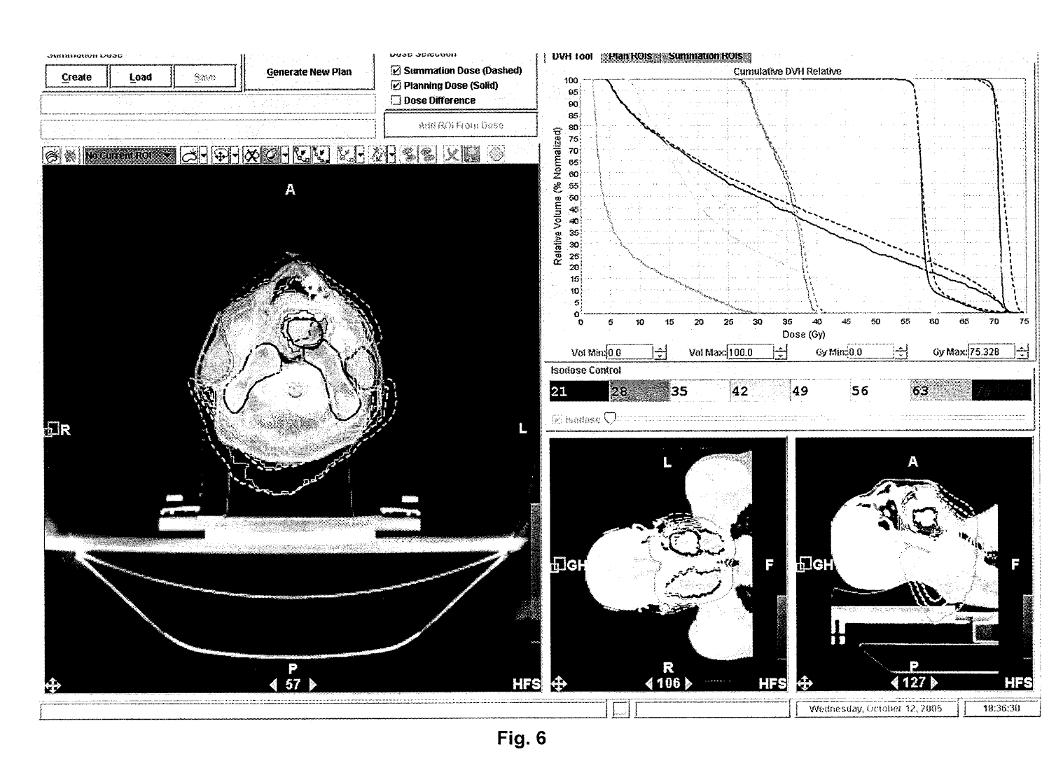

Another aspect of this invention is its flexibility to evaluate hypothetical situations. The columns 114-142 illustrated in FIG. 4 are not the only processing steps, but instead there are many additional processing possibilities that can be incorporated, representing everything from details of how the calculations are performed to big-picture goals for desired clinical comparisons. For example, details include such topics as how to pad or process incomplete images, and which algorithms to use for deformation or contouring, allowing the user to understand the effect of these items on the evaluation. Big-picture items include topics such as which plan to use for dose calculation, which images to use for planning or for the basis of dose accumulation, and which sets of doses should be accumulated and what other sets they should be compared to. By evaluating these items, a user can understand how a patient's treatment would have been affected by using different setups, different plans, adapting plans more or less frequently, etc. These are the types of cases studied in FIGS. 5 and 6. FIG. 5 compares how the original planned delivery compares to what was actually delivered incorporating both patient changes and an adaptive plan change mid-course. FIG. 6 compares how the original planned delivery compares to what would have been delivered had the adaptive plan not been used.

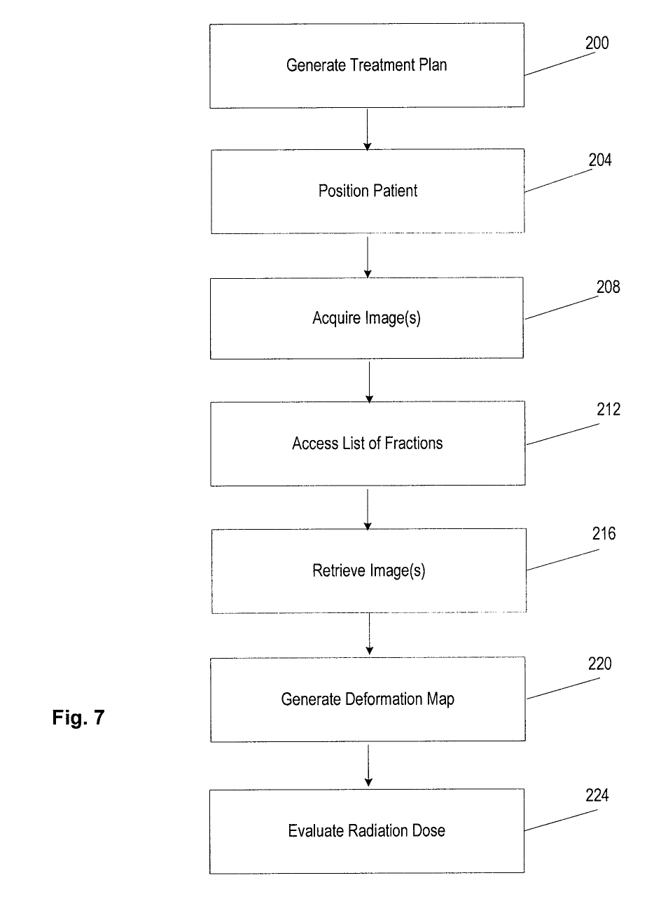

FIG. 7 is a flow chart of a method of evaluating a radiation therapy treatment plan. Medical personnel generate (at 200) a treatment plan for the patient 14 based on patient data, images, or other information. When the patient 14 is ready for a treatment, medical personnel position (at 204) the patient 14 on the couch 82 prior to delivery of treatment. A reference image of the patient 14 may be acquired to assist in the positioning. Additional positioning adjustments can be made as necessary. After the patient 14 is properly positioned, the system acquires (at 208) one or more images of the patient. Prior to initiation of delivery of the treatment plan, the user accesses (at 212) a list of fractions in the treatment plan and retrieves (at 216) an image associated with one of the fractions. The system generates (at 220) a deformation map between the reference image and the image associated with one of the fractions. Based on the deformation map, the system evaluates (at 224) a radiation dose that would have been delivered to the patient for at least one of the fractions if any of the delivery conditions or parameters were different.

Various features of the invention are set forth in the following claims.

What is claimed is:

1. A computer-generated user interface for presenting data relating to a radiation therapy treatment plan, the user interface comprising:
a list of fractions identified in the treatment plan;
data identifying delivery status of the fraction; and
data identifying a processing status of the fraction, and wherein the processing status relates to data acquired before, during, or after treatment to
retrospectively analyze the delivery.

2. A user interface as set forth in claim 1 wherein the data identifying delivery status includes an indication of whether the fraction has been delivered to the patient.

3. A user interface as set forth in claim 1 wherein the data identifying processing status of the fraction includes an indication of whether a daily image for the fraction has been processed.

4. A user interface as set forth in claim 1 wherein the data identifying processing status of the fraction includes an indication of how a daily image will be processed.

5. A user interface as set forth in claim 1, and further comprising an indication of whether a daily image has been related to a planning image.

6. A user interface as set forth in claim 1 wherein the treatment plan comprises a contour set, and wherein the user interface further comprises an indication of how a contour set will be related to other images.

7. A user interface as set forth in claim 1 wherein the treatment plan comprises a contour set, and wherein the user interface further comprises an indication of whether a contour set has been generated for new images.

8. A user interface as set forth in claim 1 wherein the interface indicates whether a dose calculation has been performed.

9. A user interface as set forth in claim 1 wherein the interface indicates the method by which a dose calculation has been or will be performed.

10. A user interface as set forth in claim 1 and further comprising an indication of how dose is to be accumulated and whether this step has been performed.

11. A user interface as set forth in claim 1 and further comprising an indication that the dose is to be accumulated using deformation and whether this accumulation was performed.

12. A user interface as set forth in claim 1 wherein the data identifying processing status of the fraction includes shading of the processed fractions.

13. A user interface as set forth in claim 12 wherein the shading is used to indicate the status of the processing.

14. A system for developing and analyzing radiation therapy treatment plans, the system comprising:
a computer processor;
a data store connected to the computer processor and storing information relating to at least one fraction of a radiation therapy treatment plan, which fraction has been delivered to a patient as part of the implementation of the radiation therapy treatment plan, information relating to a delivery status of the fraction, and information relating to a processing status of the fraction; and
software stored in a computer readable medium accessible by the computer processor, the software being operable to automatically process the information relating to the at least one fraction, and
wherein the processing status relates to data acquired before, during, or after treatment to retrospectively analyze the delivery.

15. A system as set forth in claim 14 wherein the software automatically correlates a daily acquired patient image to a planning image.

16. A system as set forth in claim 14 wherein the treatment plan comprises a contour set, and wherein the software automatically generates a new or updated contour set based on data acquired during or proximate to delivery of the fraction to the patient.

17. A system as set forth in claim 14 wherein the treatment plan comprises a dose, and wherein the software automatically performs a dose calculation based on data generated during or proximate to delivery of the fraction to the patient.

18. A system as set forth in claim 14 and further comprising means for acquiring the information relating to at least one fraction.

19. A system as set forth in claim 18 wherein the software automatically processes the data upon acquisition by the means for acquiring.

20. A system as set forth in claim 18 wherein the software automatically processes the data in response to a user input.

21. A system as set forth in claim 14 wherein the software is operable to generate a notification when results from one or more of the fractions or processing steps exceeds a predetermined threshold.

22. A system as set forth in claim 21 wherein the results exceeding the threshold are based on patient dose.

23. A system as set forth in claim 21 wherein the results exceeding the threshold are based on a deformable registration.

24. A system as set forth in claim 21 wherein the results exceeding the threshold are based on generated contours.

25. A system as set forth in claim 21 wherein the results exceeding the threshold are based on other automated steps.

26. A system as set forth in claim 14 wherein the software is operable to analyze the information relating to one or more of the fractions using a gamma index.

27. A system as set forth in claim 14 wherein the software is operable to analyze the information relating to one or more of the fractions using a xi index.

28. A method of evaluating a radiation therapy treatment plan, the method comprising:
acquiring a reference image of at least a portion of a patient;
accessing a list of fractions identified in the treatment plan for the patient, each fraction being associated with a set of delivery conditions or parameters;
retrieving an image associated with one of the fractions;
generating a deformation map between the reference image and the image associated with one of the fractions; and
evaluating a radiation dose that would have been delivered to the patient for at least one of the fractions if any of the delivery conditions or parameters were different.

29. A method as set forth in claim 28 wherein the patient is positioned in a first position.

30. A method as set forth in claim 29 wherein the radiation dose is evaluated for a patient position different from the first position.

31. A method as set forth in claim 28 wherein the radiation dose is evaluated for a patient treatment plan different from the treatment plan delivered.

32. A method as set forth in claim 28 and further comprising adjusting the treatment plan based upon the results.

33. A method as set forth in claim 28 and further comprising determining the effect of alternate delivery conditions or parameters on the cumulative treatment.

34. A method as set forth in claim 28 wherein the treatment plan includes a first image and wherein the first image is replaced with a second image.

35. A method as set forth in claim 28 wherein the reference image is an image other than a planning image.

36. A method as set forth in claim 28 and further comprising retrospectively analyzing the radiation dose delivered to the patient based on the reference image.
